(19) United States
(12) Patent Application Publication
(10) Pub. No.: US 2017/0246990 A1
(43) Pub. Date: Aug. 31, 2017

(54) Wireless Overhead Clearance Warning System

(71) Applicant: Stratom, Inc., Boulder, CO (US)

(72) Inventors: NEAL ROSENBLUM, Hollywood, FL (US); MARK ROSENBLUM, Denver, CO (US)

(21) Appl. No.: 15/445,229

(22) Filed: Feb. 28, 2017

Related U.S. Application Data
(60) Provisional application No. 62/301,376, filed on Feb. 29, 2016.

(51) Int. Cl. B60Q 9/00; B60R 16/03

(52) U.S. Cl. CPC B60Q 9/008; B60R 16/03

(57) ABSTRACT

A system for warning a driver of a cargo container transport vehicle to intervene in the case of an impending overhead collision with low clearance infrastructure. Examples of container/transport systems include but are not limited to a single-unit truck, a truck/semi-trailer combination or a vehicle pulling a hitched cargo container such as a camper, horse transporter, or moving container.

### CROSS REFERENCES

This application claims priority to U.S. Provisional patent application No. 62/301,376, titled “WIRELESS OVERHEAD CLEARANCE WARNING SYSTEM,” filed Feb. 29, 2016, which is incorporated by reference in its entirety for all purposes.

### BACKGROUND

A large segment of vehicles that are transporting cargo are driven by untrained drivers or drivers who do not perform this type of cargo hauling operation on a regular basis. Since the driver does not perform this type of task often, they may have a tendency to forget about the attached cargo container and make vehicle control judgments based on the dimensions of the cab they are sitting in rather than the cargo container they are transporting. If this lapse in driver judgment occurs in an environment with low overhead clearance, the cargo container can collide with the low handing overhead structure.

The immediate results of these types of overhead collisions are severe damage to the cargo container, and severe damage to the low hanging infrastructure involved in the collision. There have even been cases where the occupants of the cab experienced severe injury or death when pieces of the infrastructure fell on top of the cab and crushing it with the occupants inside. Other impacts of these types of overhead collisions include: the shipment of the cargo is delayed, the cargo inside the damaged container is also damaged, the cargo damage is extensive requiring costly and time consuming repair, and the transport vehicle is out-of-commission and not performing its designated transport tasks.

These types of overhead collisions could be dramatically reduced if a warning system was in place that alerted the driver well ahead of an impending overhead collision. With sufficient warning, the driver could have the opportunity to avoid the collision by stopping the vehicle before the overhead collision takes place. If on closer visual inspection, the driver determines there is enough vertical clearance between the profile of his vehicle/cargo container and the low overhead structure, then he can safely proceed.

### SUMMARY

Various aspects of the present disclosure are directed to a low overhead clearance sensor module and a driver warning module. The low overhead clearance detector module may be mounted at or near the highest point of a cargo structure of a vehicle, with the sensor facing in the general direction of vehicle travel. The sensor module, in some examples, will be active, meaning it will transmit energy waves as sound or light, or combinations thereof, that will be reflected off of environmental infrastructure and received by a detector in the sensor module in order to determine distance and closing rate of low overhang infrastructure relative to the transport vehicle. In examples where the sensor is active, it will operate in day or night conditions.

The warning module may be located in the cab of the transport vehicle so a vehicle driver can be alerted to potential overhead collisions. The warning signal may be an audible stimulus, a visual stimulus, or combinations thereof. In some examples, a visual stimulus may be selected to provide a warning to a driver that may be hearing impaired. The sensor module mounted on the cargo container and the warning module located in the cab, in some examples, may communicate wirelessly, such as, for example, through either a WiFi (i.e., wireless communications based on the IEEE 802.xx wireless protocols) or Bluetooth® communication channel, or combinations thereof. One or both of the sensor module and the warning module may be battery powered. In some examples, one or both of the sensor module or the warning module may include rechargeable batteries that may be charged using small solar panels connected to each respective module. In other examples, one or both of the sensor module or the warning module may be powered through vehicle-supplied power, such as through an adapter plugged into the cigarette lighter, power port, or other connection to vehicle power. The rechargeable batteries of some examples may be selected to provide sufficient capacity to allow the respective module to operate for up to eight hours, allowing the entire system to operate in both day and night conditions.

The low clearance warning system of various aspects of the present disclosure is not intended to be a precise measurement system, but a device to remind the inexperienced or infrequent driver in situations of low overhead clearance that they are hauling a tall load and that there is a potential for an upcoming overhead collision.

### BRIEF DESCRIPTION OF THE DRAWINGS

The accompanying drawings, which are incorporated in and form a part of this specification, illustrate various aspects of the present disclosure and, together with the description, serve to explain the principles of the invention.

FIG. 1—is the self-contained wireless overhead clearance warning system installed on a single-unit truck;

FIG. 2—is the embodiment 1 of Sensor Module with controller contained within the module;

FIG. 3—is the embodiment 2 of Sensor Module with controller contained within the module;

FIG. 4—is the warning module suction mounted on dashboard;

FIG. 5—is the warning module suction mounted to windshield;

FIG. 6—is an example of visual indicators of a warning module; and

FIGS. 7-8—are flow charts of operational steps of an overhead warning system of various aspects of the disclosure.

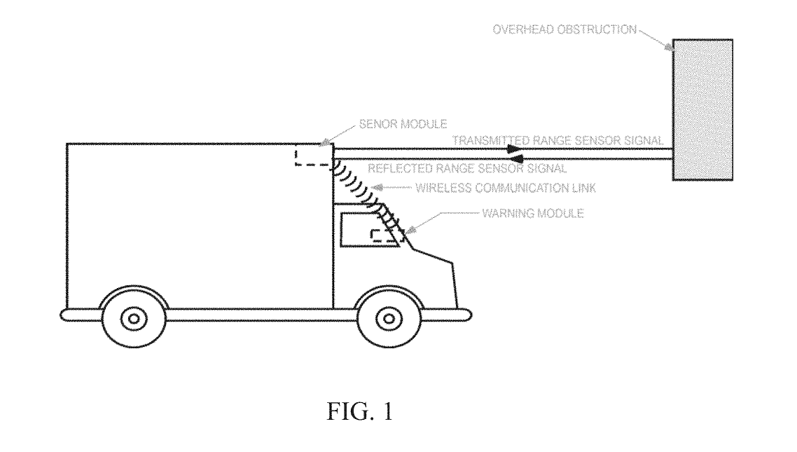

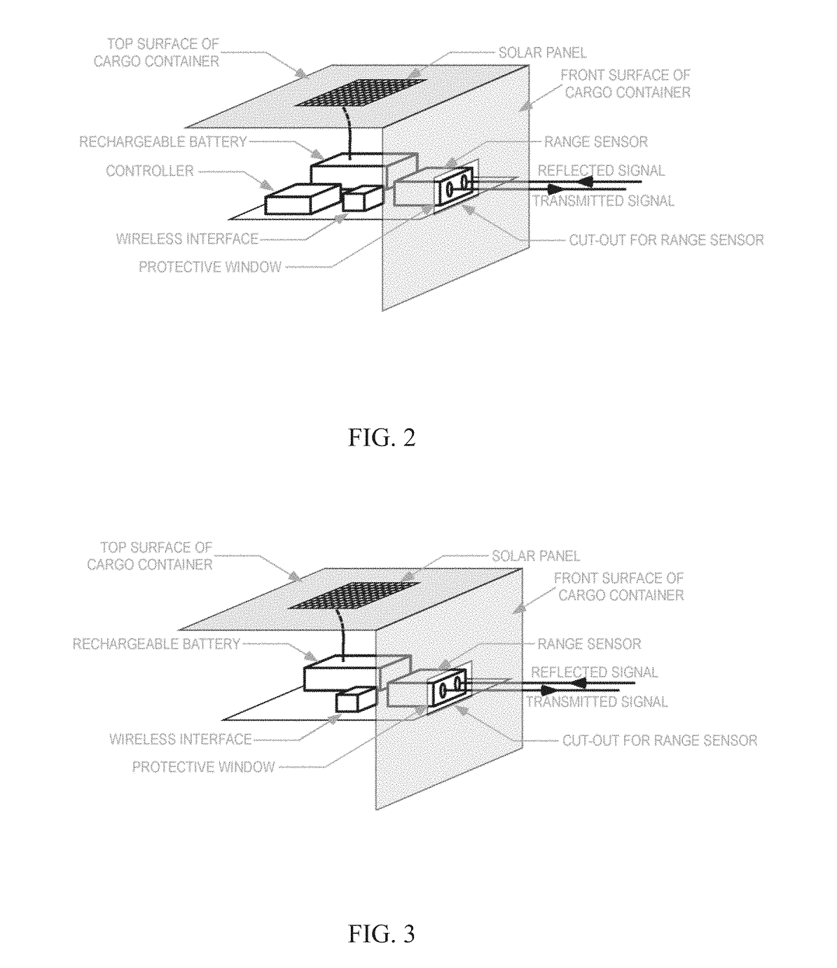

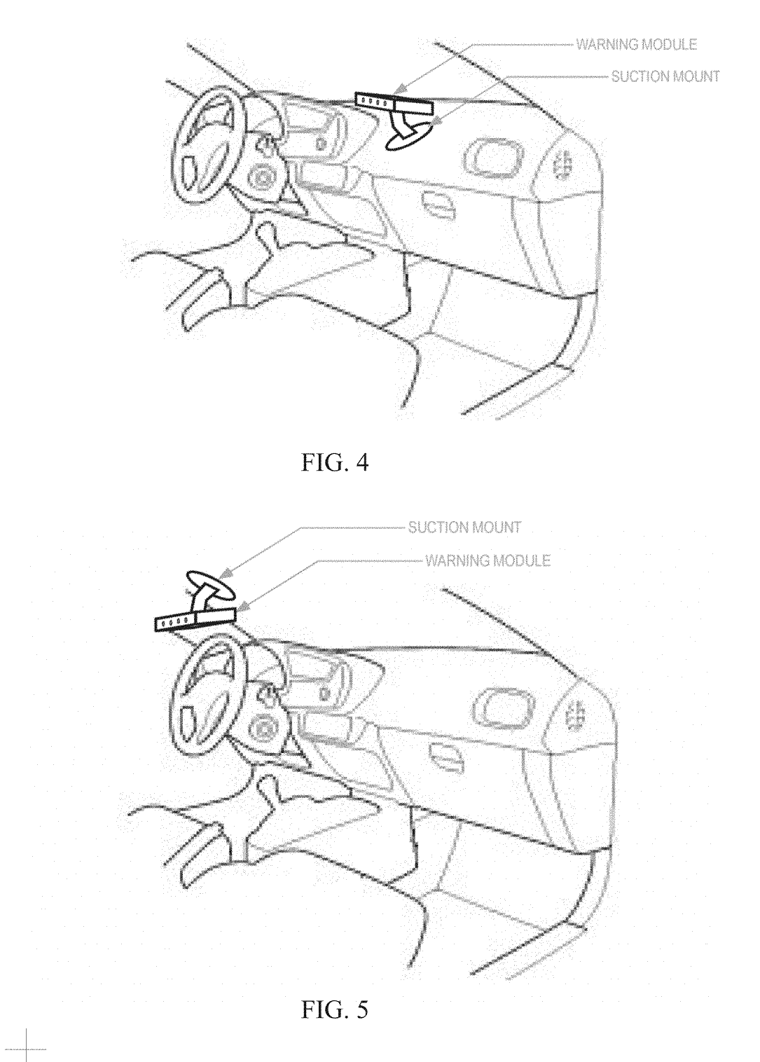

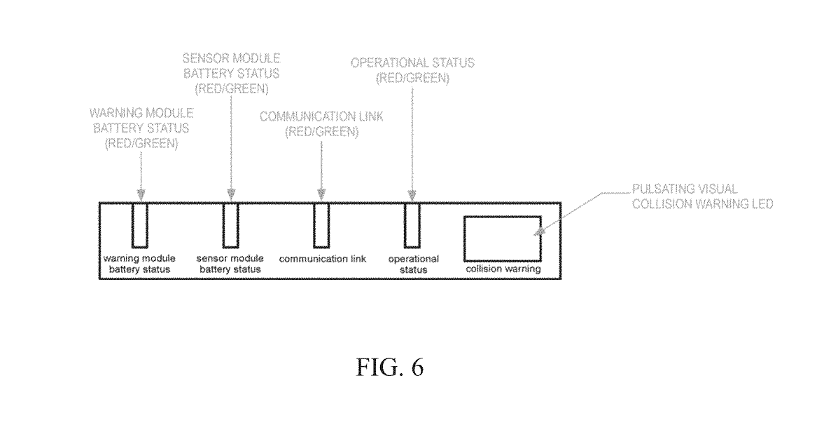

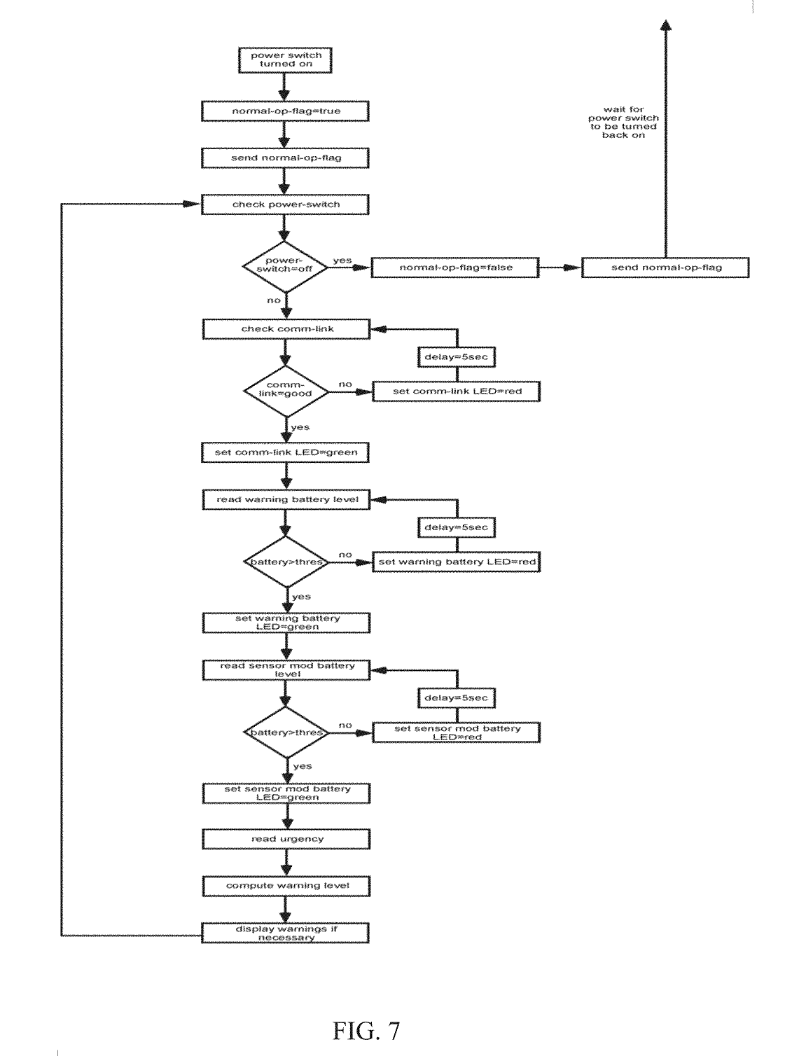

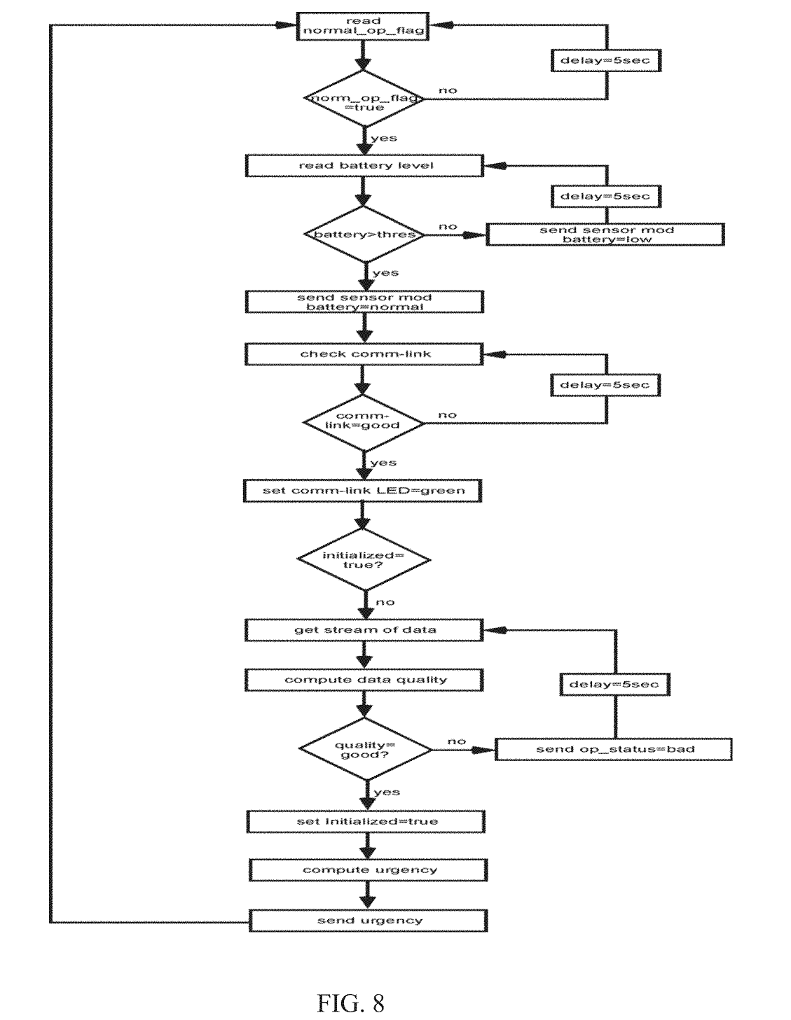

### DETAILED DESCRIPTION

Definitions:

Unless otherwise specified, a cargo container is an enclosed volume that is transported by a vehicle which in most cases would be a truck but not necessarily limited to a truck. The cargo container can be fixed to the vehicle frame as in the case of a single-unit-truck or pulled by the transport vehicle by a trailer or hitch mechanism as in the case of a truck/semi-trailer combination or a pickup truck/camper combination. A significant aspect of these configurations under the context of the present disclosure is when the vertical profile of the cargo container exceeds the vertical profile of the transport vehicle.

Unless otherwise specified, all references to overhead obstructions refer to any obstruction that would make impact with a cargo container being transported by a vehicle as described above if the vehicle continued its forward motion towards the overhead obstruction. These obstructions can include but are not limited to a parking garage ceiling, a garage entry way, a drive-thru structure such as that encountered at a drive-thru restaurant or bank, an overpass, a building canopy, or natural foliage such as tree limbs.

Various aspects of the present disclosure provide a low overhead clearance system that may detect low overhead clearance and provide a warning to a driver of a vehicle. The description herein is provided with reference to the drawing figures, in which various examples of the disclosure are illustrated. The system may include a low overhead clearance sensor and a warning module. The low overhead clearance sensor may detect potential overhead obstructions out to a distance that gives the driver of the transport vehicle enough time to respond. The main driver response to overhead warnings is to stop the vehicle before a potential collision. If the low overhead clearance warning occurs on a roadway, the driver may want to pull off to the side of the road while stopping. The faster the transport vehicle is driving, the further out the low overhead clearance sensor must detect obstructions in order for the driver to stop the vehicle in sufficient time before reaching the obstruction. For example, at 60 miles per hour (mph), a vehicle will travel 27 meters in one second. Assuming it takes the driver a half second to respond, the distance traveled in bringing the vehicle to a complete stop could be as great as 160 meters, depending upon the braking capability and weight of the vehicle. Therefore, an overhead warning system on such a vehicle would need to be able to detect overhead obstructions at distances greater than 160 meters in order to provide time for the vehicle to stop, in this example. This relationship is non-linear and is dictated by basic kinematic equations. For instance at 40 mph, the required detection distance is only 70 meters (assuming the above response time and typical braking capability). Thus, as required detection distance increases, the required range of the detection sensor may need to be extended. This will require a greater transmission signal strength (for active overhead clearance sensors) and more sensitive electronics to interpret a weaker reflected signal; both increasing the sensor cost. In addition, pointing errors and beam dispersion can lead to more false positives with at greater detection distances. Accordingly, in some examples of the present disclosure device operation may be limited to 40 mph or less, leading to a 70 meter detection distance requirement, in order to provide a relatively low cost and reliable system. It will be understood that the concepts disclosed herein will be equally applicable to systems with greater or less range or maximum vehicle speed for reliable operation. The device of several examples herein, designed for a maximum operating speed of 40 mph, will still operate at higher speeds, but any warning may not give the drive ample time to respond to the potential overhead obstruction.

The sensor module component of an overhead clearance warning system of various examples may include an active sensor, a rechargeable battery, a solar panel, a wireless communication interface, and in some cases a controller. One embodiment can have the controller in the sensor module and other embodiments provide the sensor processing logic on a controller residing in the warning module that receives the raw sensor data from the sensor module through the wireless communication channel. It is possible that this second embodiment can lower overall system cost, but with an added burden on the controller residing in the warning module because it now has to perform additional processing.

The software implementation of the logic loop that controls the sensor module will be similar source code whether it resides on a controller in the sensor module or on the controller in the warning module. The main difference is the access to the data produced in the sensor module. If the controller resides in the sensor module, it will have direct access to the necessary data. If the software is running on the controller in the warning module, data will need to be obtained through the wireless communication link. The sensor module in such configurations may be hardwired to directly transmit the raw data produced in the sensor module, such as the raw sensor data, over the wireless link. These two example configurations describe two separate embodiments of the invention, but the underlying software logic is essentially unchanged and therefore when referring to the controller running the sensor module software, it could reside in the sensor module or the warning module. In further examples, a separate processing module may be provided that may be connected to one or both of the sensor module or controller module via wired or wireless connections.

The sensor module, in some examples, may be mounted inside the cargo container with an opening provided through the cargo container for the detection sensor. The sensor module may be mounted at or near the highest point of the cargo container with the detection sensor facing forward in the direction of vehicle travel. In other examples, the sensor module may be a separate module that may be mounted to the top, front, or side exterior surface of the cargo container.

The overhead clearance detection sensor, in various examples, will emit a signal and sense its reflectance to obtain range information to potential overhead obstructions. The emitted signal could be sound, light, radio, radar, or combinations thereof, and may allow the system to operate in day or night-time conditions. Light-based ranging sensors may work at longer ranges and have greater target selectivity since there is less beam divergence, but sensors of embodiments may employ any technology that can provide accurate range with a narrow target selectivity. The techniques used to produce a range measurement from the received reflected signal are time-of-flight, triangulation and signal shape correlation between transmitted and received reflected signals. This processing may be performed internal to the sensor with the sensor outputting a processed range value over a standardized interface, such as RS-232.

It is possible that the emitted signal could be negatively impacted by airborne precipitation such as rain, snow, sleet and fog. In this event, the sensor module software of some examples will detect this signal degradation and either account for it in the sensor filtering and smoothing algorithm or deactivate the system until environmental conditions improve. When the environmental conditions return to nominal state, the system may automatically go into operational mode if it is still powered up. In such cases, notifications may be provided to the vehicle operator indicating the system is disabled or re-enabled.

Systems of some examples may use of off-the-shelf range sensors that meet operating requirements for a particular deployment (e.g., that meet processing requirements for 40 mph travel speed and 160 meter stopping distance). In some examples, once the range measurement is made, the range value is sent to the controller. The sensor processing software will compute a closing velocity to an overhead detection based on the sequence of distance measurements within a time window.

It is important in any warning system that the system does not experience an excessive number of false detections. In systems that experience too many false positives, drivers have a tendency to start ignoring the warnings which could be catastrophic if a warning is not a false positive. The false detections will be reduced to a manageable level in some examples through the use of one or more filtering and smoothing algorithms associated with the range sensor processing.

Based on these smoothed estimates, a software function may then compute a level of potential overhead collision urgency as a number between one and ten with ten being the greatest urgency. This number may then be provided to the software functions associated with the warning module functionality. The warning module related software will ingest the newly computed urgency number and determine what level of warning to convey to the driver. In some examples, the level of warning may be selectable.

The sensor module, of some examples, will contain a rechargeable battery that when fully charged will have the capacity to run the sensor module for eight hours at full load with no charging allowing for operation in darkness for that duration. The sensor module battery in such cases may be charged by a solar cell. In some cases the charging capacity of the solar cell is selected to exceed the power draw from the battery, allowing the battery to recharge even if the system is in full operational mode. In other examples, non-rechargeable batteries may be used and/or the system may obtain operating power from the vehicle.

The solar cell that is part of the sensor module, in embodiments that employ such a power source, may require a separate small opening cut in the cargo container to allow ambient light to impinge on the solar cell. The two openings that need to be cut for the sensor and the solar cell in such embodiments will be relatively small and close to each other. During installation of the sensor module, the openings shapes can be traced onto the container surface using an installation template. As part of the design in some embodiments, both the sensor and the solar panel will have weather seals to prevent leakage into the cargo container. The sensor itself will not be directly exposed to the elements and may be behind a small protective window that will not impede the transmission or reception of the active signal. In other embodiments, as mentioned above, the sensor module may be provided in a self-contained enclosure that may be mounted to a vehicle cargo container (e.g., on the top, front, or side of the cargo container.

The warning module of various embodiments is located in the cab where the driver resides. The warning module of some examples may include a set of status indicator LEDs, an audible device, a wireless device to receive messages from the remotely mounted sensor module, a controller, a rechargeable battery and an external solar cell and/or power adapter that can plug into the vehicle cigarette lighter (or other power source). The main purpose of the warning module is to convey system status to the driver and to alert the driver when there is a potential overhead clearance violation requiring driver intervention. In various embodiments of the warning module, the driver can be alerted using any number of human sensing modalities from visual, audible to tactile. In the embodiment discussed herein, the sensor combines a visual stimulus with and audible stimulus such that even if the driver is hearing impaired, he/she can utilize the warnings that the visual system provides.

In some examples, a warning system may convey critical information to the driver in a very simple, intuitive and efficient manner that does not distract the driver's attention from the driving task. Warning system design of some examples recognizes that the human sensing system, no matter what modality, is sensitive to transitions in stimulus (e.g., this is a reason that many warning systems involve an oscillating warning signal such as a flashing light or a beeping sound). The urgency of the warning can be reflected in the frequency of the signal oscillation, i.e., a more urgent warning is associated with a shorter oscillation period of the signal (e.g., as used in some types of audible warning systems for backup warning systems on vehicles where closer backup threats are conveyed by a higher frequency pulsed audible warning). Some examples of warning systems of the present disclosure convey urgency with a similar mechanism, which may include one or both of visual or audible signals. Visual warnings of some examples may be implemented using pulsing LED that pulses with greater frequency as the overhead clearance threat increases. In certain examples, concurrently with the visual warning, an audible signal may also sound that varies its oscillation frequency in a similar manner. When there is no threat in such examples, the system does not make an audible sound or provide a visual indication.

The warning module in addition to providing the overhead collision warning signal may also display various aspects of system status. The types of status information that may be conveyed through LED indicators include the state of the battery charge in the sensor module, the state of the battery charge in the warning module, the state of communication pairing between the sensor and warning modules and the state of operation of the device as a whole, i.e., is it operating appropriately. This final status can be affected by the environmental operating conditions such as rain, snow or fog. In environmental conditions that prove too challenging for the system due to high levels of sensing noise, the system may deactivate and change the status of the warning module indicator to failure until nominal operating conditions return.

The warning module for the overhead clearance warning system, as discussed above, may be located in a vehicle cab in a highly visible location relative to the driver but not obstructing the driver's view. There are several possible embodiments where the warning module could be mounted on the windshield or on the dash with a suction mount. The warning module may receive its power either from an adapter plugged into the cigarette lighter, other power source within the vehicle, or through a small solar panel that charges a battery within the module. The charger rate either through the solar cell or through the vehicle power adapter in various examples will exceed the maximum power usage of the warning module so it will be able to charge under full operational load. In some examples, when fully charged, the battery in the warning module will support eight hours of continuous operation.

In order to activate the overhead collision warning system in various examples, the driver may physically turn on a switch on the warning module located in the cab. This will have the effect of providing power to the components of the warning module and causing a change in the state of the “normal operation” flag from false to true which will be intercepted by the sensor module software. The sensor module of some examples will always be on, unless the battery has been fully discharged. If the system was not powered on by the switch on the warning module, then the sensor module may remain in a low power sleep state. The sensor module software in the sleep state will intermittently poll the “normal operation” flag (e.g., every five seconds) for a true state. On the transition to this state, the sensor module will transition out of sleep mode to the full power normal operational mode. In this mode, the range sensor will be powered up and the sensor module software will begin to initialize.

The initialization stage of the sensor module software may operate to make sure that all of the sensor module subsystems have come up properly, the battery has a sufficient charge and there is communication with the warning module which may be indicated by a heart-beat signal sent from the warning module to the sensor module software. When all of these startup tests succeed, the sensor module software logic may then enter an operational loop. In some embodiments, this loop has three logical sections. The first is to convey the sensor module status information to the warning module. This includes an operational status flag that will be affected by the weather conditions, a heart-beat signal from the sensor module software to the warning module indicating to the warning module software that the sensor module software is cycling properly and a sensor module battery status (charged or low-battery). The second logic block of the sensor module software operational loop is to check to see if the warning module is still requesting normal operation. This may be indicated by a consistent true value for the “normal operation” flag sent from the warning module to the sensor module software. A false value means the warning module has been turned off or has malfunctioned. This is the same flag this is polled in the sleep mode of the sensor module software to initiate runtime operation. The third logical block of the sensor module software operational loop reads the range sensor data, filters those readings and then computes an urgency value that will get sent to the warning module. This loop will run continuously unless one of the following conditions occurs: 1) there is a failure with a subcomponent in the sensor module, 2) the sensor module battery completely discharges or 3) the sensor module receives a false value on the normal operation flag sent from the warning module.

When power is turned on by the driver at the warning module, the warning module software may go through an initialization stage which involves waking up the sensor module hardware and software and to check that every component of the system is functioning properly. Once these tasks have been completed, the warning module software logic transitions to a runtime loop. In some embodiments, the first part of this software loop monitors the power switch on the warning module. When power is turned off, the warning module software sends a false value for the normal operation flag causing the sensor module hardware and software to go into sleep mode. The next stage of the runtime loop is to read and display the status of the system through the indicator LEDs on the warning module. The last stage of the warning module runtime loop is to read the urgency value published by the sensor module software and to produce a commensurate visual/audible warning if necessary. Greater urgency values will lead to an increased pulsating frequency of both the visual and audible warning signal.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

The various illustrative blocks and modules described in connection with the disclosure herein may be implemented or performed with a general-purpose processor, a digital signal processor (DSP), an ASIC, an field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be performed by one or more other processing units (or cores), on at least one integrated circuit (IC). In various examples, different types of ICs may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

1. An overhead object warning apparatus, comprising:
a sensor component comprising an overhead object sensor; and
a warning component coupled with the sensor component comprising a receiver in overhead object receiving communications with the sensor component and an overhead object indicator configured to indicate a warning in the event an overhead object is detected.

2. The apparatus of claim 1, wherein the sensor component is mounted to a vehicle at or near a top of a cargo portion of the vehicle and comprises one or more forward looking sensors configured to detect an overhead object forward of the cargo portion of the vehicle.

3. The apparatus of claim 2, wherein the one or more forward looking sensors comprise one or more of an optical sensor or an acoustic sensor.

4. The apparatus of claim 3, wherein the optical sensor or the acoustic sensor transmits a signal, receives a reflection of the signal from an overhead object, and determines, based at least in part on the received reflection, that the overhead object presents a threat to the cargo portion of the vehicle.

5. The apparatus of claim 1, wherein the sensor component and the warning component are self-contained modules configured to be mounted to a vehicle.

6. The apparatus of claim 5, wherein one or both of the sensor component or the warning component comprise a solar charging power source.

7. The apparatus of claim 5, wherein one or both of the sensor component or the warning component comprise a power adapter configured to be coupled with a power source of the vehicle.

8. The apparatus of claim 1, wherein the sensor component is mounted to a vehicle at or near a top of a cargo portion of the vehicle and comprises one or more forward looking sensors configured to detect an overhead object within a first distance forward of the cargo portion of the vehicle.

9. The apparatus of claim 8, wherein the first distance is approximately 70 meters.

10. The apparatus of claim 1, wherein the warning component is wirelessly coupled with the sensor component.

11. The method of claim 10, wherein the warning component comprises a mounting element configured to be coupled with an interior of a vehicle cab in proximity to a vehicle driver.

12. The apparatus of claim 10, wherein the overhead object indicator comprises one or more of an audible indicator or a visual indicator to ward a vehicle driver of a potential overhead object in the path of the vehicle.
